(19) United States
(12) Patent Application Publication
(10) Pub. No.: US 2006/0131337 A1
(43) Pub. Date: Jun. 22, 2006

(54) Apparatus and method for efficient dispensing of fluids from a container

(76) Inventor: Lee Mertins, Whitesboro, TX (US)

Correspondence Address: Schultz & Associates, P.C., Suite1200, 5400 LBJ Freeway, Dallas, TX, 75240, US

(21) Appl. No.: 11/019,064

(22) Filed: Dec. 21, 2004

(51) Int. Cl. B67D 5/64

(52) U.S. Cl. 222/164; 222/464.4

(57) ABSTRACT

The invention provides an apparatus and method for tipping and efficiently drawing fluid from a bucket or container. In one exemplary embodiment, the apparatus includes a frame, a bracket attached to the frame, a pressure sprayer connected to a suction hose, and a guiding rod placed through the bracket and connected to the suction hose. In another exemplary embodiment, the device includes a bracket attached directly to the pressure sprayer. In one example, the bracket is made of a rigid metal alloy capable of supporting 5 gallons of paint. In use, the sprayer draws liquid from the container through the suction hose. As the container is emptied of fluid, the spring action provided by the handle raises the container. The guiding rod does not allow the bottom corner of the container to move; therefore, the container tilts toward the bottom corner forcing a pooling of liquid within reach of the suction hose. This invention also provides a rounded filter attached to the end of the suction hose which matches the bottom corner of the container and enhances the ability of the suction hose to gather fluid from low levels in the container.

### FIELD OF THE INVENTION

This invention relates to an apparatus and method for efficient dispensing of fluids from a container. In particular, the invention relates to an apparatus and method that permits a majority of fluid to be removed from a container. More particularly, the invention relates to an apparatus and method that releasably holds the suction hose of a pressure sprayer to the bottom corner of a container and causes it to tilt as the fluid in the container is removed by the spring contraction of the container handle.

### BACKGROUND OF THE INVENTION

Pressure sprayers are typically used for a number of projects which require dispensing of liquids from containers. Pressure sprayers are generally mounted on a movable cart to allow for portability. They include at a minimum a motor, compressor, suction hose, fluid container and a high pressure hose and nozzle.

Typically, fluid is drawn from the container through a hose connected to the low pressure side of the compressor. The hose is placed directly into the container of fluid. During use, when the container is nearly empty, the level of the fluid falls below what the hose can reach, causing air to be drawn into the compressor and cessation of spraying activities.

Prior art sprayers are shown in U.S. Pat. No. 6,701,975 to Neal and U.S. Pat. No. 5,842,639 to Walker; and Japanese Patent No. 63,317,484 to Toru.

A need exists for an apparatus and method that allows for complete use of the fluid in the container and consequent reduction in the amount of fluid wasted.

### SUMMARY OF INVENTION

The invention provides an apparatus and method for tipping and efficiently drawing fluid from a bucket or container. In one exemplary embodiment, the apparatus includes a frame, a bracket attached to the frame, a pressure sprayer connected to a suction hose, and a guiding rod placed through the bracket and connected to the suction hose. In another exemplary embodiment, the device includes a bracket attached directly to the pressure sprayer. In one example, the bracket is made of a rigid metal alloy capable of supporting 5 gallons of paint.

In use, the sprayer draws liquid from the container through the suction hose. As the container is emptied of fluid, the spring action provided by the handle raises the container. The guiding rod does not allow the bottom corner of the container to move; therefore, the container tilts toward the bottom corner forcing a pooling of liquid within reach of the suction hose.

This invention also provides a rounded filter attached to the end of the suction hose which matches the bottom corner of the container and enhances the ability of the suction hose to gather fluid from low levels in the container.

Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF THE DRAWINGS

A better understanding of the invention can be obtained from the following detailed description of one exemplary embodiment when considered in conjunction with the following drawings in which:

FIG. 1A is a side view depicting an exemplary embodiment of the device.

FIG. 1B is a front view depicting an exemplary embodiment of the device.

FIG. 2 illustrates a first exemplary embodiment of the device including a bracket, a guiding rod, a hose and a filter.

FIG. 3A is an isometric view of depicting the bracket in accordance with the invention.

FIG. 3B is a bottom view depicting the bottom piece of the bracket in accordance with the invention.

FIG. 3C is top view depicting the bracket in accordance with the invention.

FIG. 3D is a side view depicting the bracket in accordance with the invention.

FIG. 3E is an isometric view depicting an alternate design of the bracket in accordance with the invention.

FIG. 4A is a detailed view depicting of the hose and the filter in accordance with the invention.

FIG. 4B is a side view of the top of the hose filter in accordance with the invention.

FIG. 4C is an isometric view of the end of the hose and the filter in accordance with the invention.

FIG. 5A is a side cross-sectional view of the end of the hose and the filter in accordance with the invention.

FIG. 5B is a bottom cross-sectional view of the end of the hose and the filter in accordance with the invention.

FIG. 6 depicts the guiding rod in accordance with the invention.

FIG. 7A is a side view depicting the apparatus in the “storage” position in accordance with the invention.

FIG. 7B is a side view depicting the apparatus in the “use” position in accordance with the invention.

FIG. 8 is a top view depicting the position of the filter and the hose relative to a container in accordance with the invention.

FIG. 9A depicts the forces acting on the container used in accordance with the invention when the container is full.

FIG. 9B depicts the forces acting on the container used in accordance with the invention when the container is substantially empty.

FIG. 10 illustrates a second exemplary embodiment of the device in accordance with the invention.

FIG. 11A is a front view depicting a container of the second exemplary embodiment in accordance with the invention.

FIG. 11B is an isometric view depicting a bracket of the second exemplary embodiment in accordance with the invention.

FIG. 12A is a front view depicting the bracket of the second exemplary embodiment in conjunction with the guiding rod and the filter in accordance with the invention.

FIG. 12B is a side view depicting the bracket of the second exemplary embodiment in conjunction with the guiding rod and the filter in accordance with the invention.

FIG. 13 depicts a hose and a filter compatible with the second exemplary embodiment in accordance with the invention.

### DETAILED DESCRIPTION OF THE PREFERRED EMBODIMENT

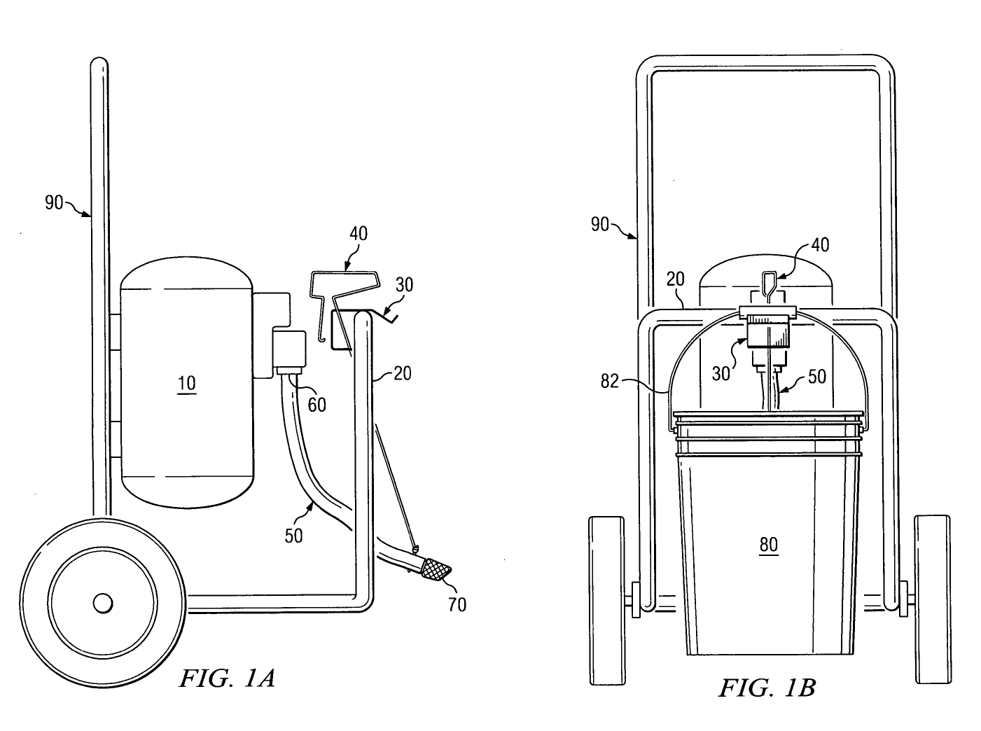

Pressure sprayers in general include a motor, a compressor and a coupling for attachment of a suction hose to draw liquid from a container. Referring now to FIGS. 1A and 1B, a side and front view of the device according to a first embodiment is shown generally in relation to pressure sprayer 10, mounted onto movable cart 90 where the frame of the movable cart includes overhead bar 20 supporting container 80. Movable cart 90 allows easy transportation of the sprayer and container. Overhead bar 20 is located in the front of movable cart 90. The overhead bar serves the purpose of supporting bracket 30 on which handle 82 of container 80 may be hung.

Pressure sprayer 10 in the preferred embodiment is a commercial pressure sprayer which includes models manufactured by companies such as Campbell-Hausfeld and Wagner. In the preferred embodiment, the container is a 5-gallon bucket with a metallic semicircular pivoted handle made of heavy gauge steel wire. In the preferred embodiment, the fluid in the bucket is paint. Of course, other containers and fluids can be used with the apparatus as will be appreciated by those skilled in the art.

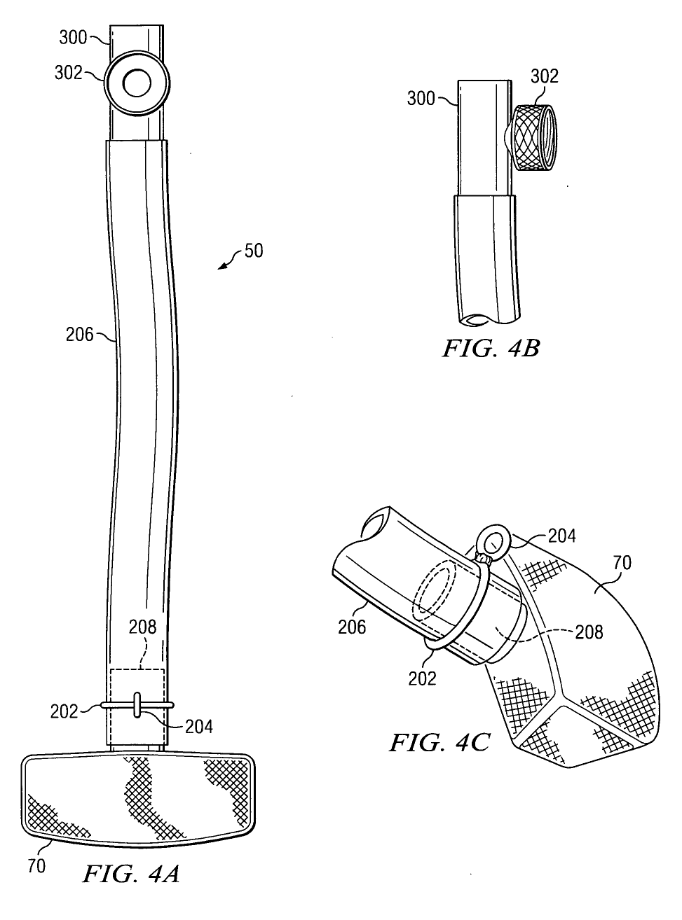

Bracket 30 is securely fastened to overhead bar 20. As shown in FIG. 1B, container 80 hangs by handle 75 from bracket 20. Because bracket 20 is used to bear the weight of the container, a preferred embodiment of bracket 20 is constructed of metal or some other rigid material capable of bearing a significant amount of weight. Suction hose 50 is shown coupled to opening 60 of the low pressure side of the compressor of the pressure sprayer. Hose 50 is detachable from the pressure sprayer. The opposite end of hose 50 is fitted with filter 70. Filter 70 and hose 50 are described in detail in FIGS. 4A, 4B, and 4C.

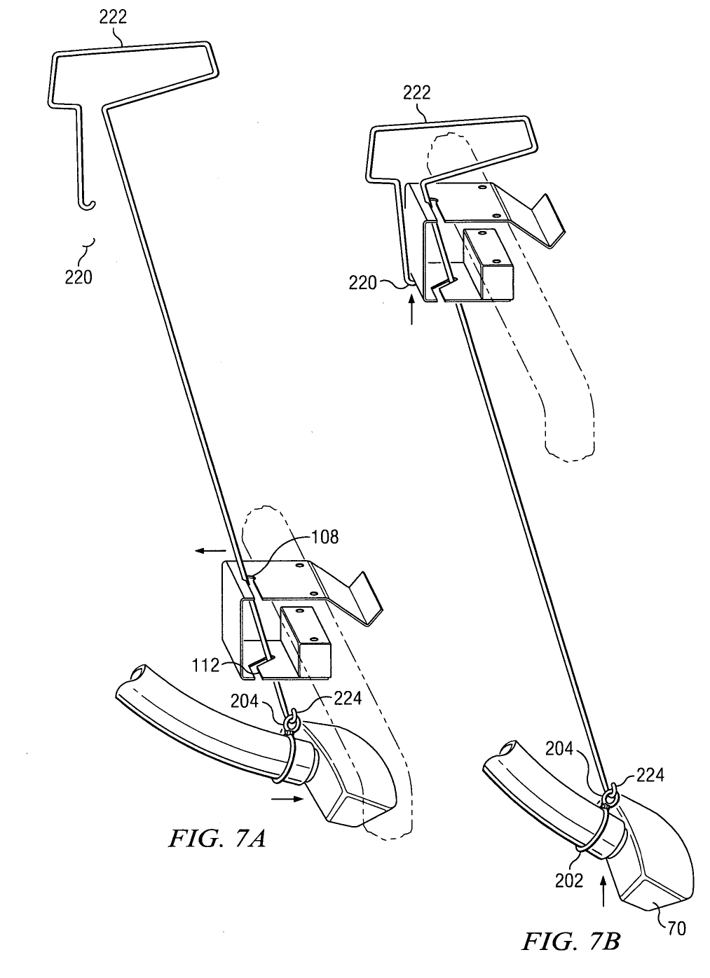

Also depicted in the system of FIGS. 1A and 1B is guiding rod 40 which is inserted and locked into two slots on bracket 30. The slots of bracket 30 and their relationship with guiding rod 40 are described in relation to FIGS. 7A and 7B.

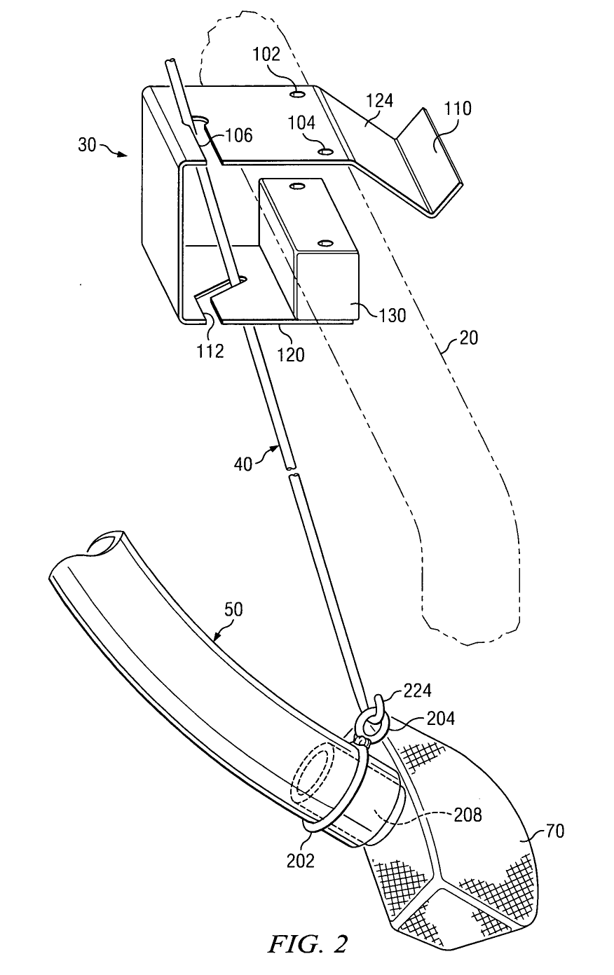

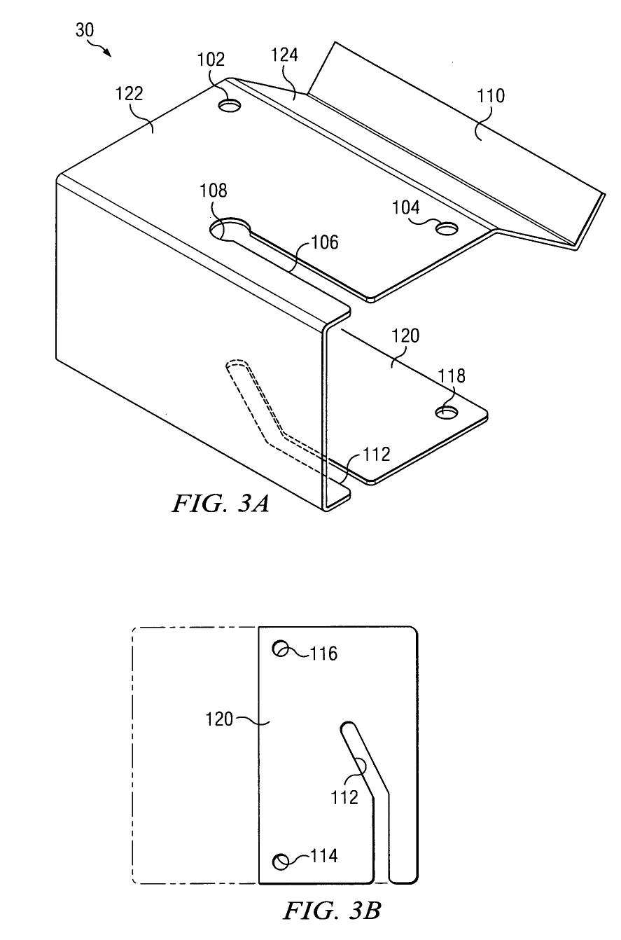

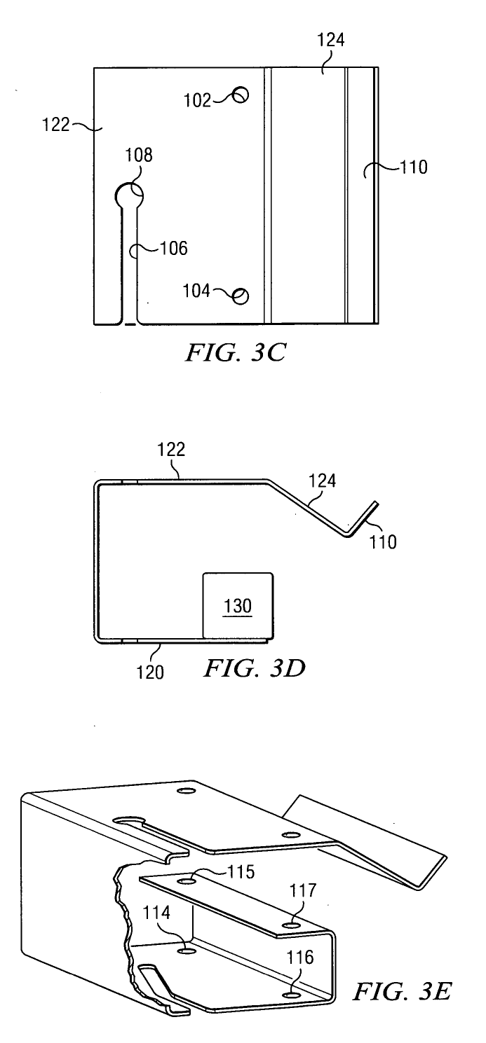

Moving to FIG. 2, an exemplary embodiment of the apparatus according to the present invention is shown. FIG. 2 depicts bracket 30 fastened to overhead bar 20. Bracket 30 is fastened to overhead bar 20 by using screws or bolts. In the alternative, it may be welded or secured through an adhesive. Spacer 130 is inserted between the bottom of overhead bar 20 and the bottom portion of bracket 30. Spacer 130 may be of different thicknesses to allow use of the device with different sized overhead bars as provided on different models of pressure sprayers. In the preferred embodiment, the bottom piece of bracket 30, spacer 130 and overhead bar 20 each have holes in corresponding locations for securing the 3 pieces together with machined bolts. The size of spacer 130 should be chosen so that when the screws are tightened, the three pieces are secured firmly. The location of these screw holes will be described in more detail in a separate description of bracket 30 in FIGS. 3A, 3B, 3C, 3D. In an alternative embodiment, spacer 130 may be replaced by adjusting the dimensions of the bracket to fit the width of overhead bar 20. The alternate design is shown in FIG. 3E.

In further reference to FIG. 2, guiding rod 40 is inserted into two slots 112 and 106 in the top and bottom portions of bracket 30. The exact shapes of the slots are further described in FIGS. 3A, 3B, and 3C. The slots position guiding rod 40 aid in holding it in the storage position. Guiding rod 40 is attached to ring 204 built into clamp 202 fastened onto hose 50. Guiding rod 40 controls and stabilizes hose 50 and filter 70 of the invention. A description in relation to FIGS. 7A and 7B show how guiding rod 40 controls and positions hose 50.

Referring now to FIGS. 3A, 3B, 3C and 3D, depicted is bracket 30 of the preferred embodiment shown from an isometric view, a bottom view, a plan and a side view, respectively. As depicted in FIG. 3A, the bracket is one piece bent having three sections. First is top flat portion 122 which is generally parallel to the bottom portion of bracket 120. The top portion includes a downward angled portion 124 connected to top flat portion 122. Connected on the other side of downward angled portion 124 is an upward angled portion 110. The purpose for two angled portions 124 and 110 is to provide a holder for the handle of the container. The holder creates a channel which prevents the handle from sliding or falling from bracket 30. In the preferred embodiment, the bracket is manufactured as a single piece.

FIGS. 3A and 3C show the openings on top flat portion 122. Slot 106 and circular groove 108 are shown as well as two holes for screws 102 and 104. Slot 106 allows the rod to slide into the top flat portion of bracket 30 and rest in circular groove 108. The circular groove secures the rod to prevent it from sliding out of the groove. Holes 102 and 104 correspond with holes in the top of overhead bar 20 so that bracket 30 may be fastened to the bar.

Bracket 30 includes bottom portion 120 depicted in more detail in FIG. 3B. Bottom portion 120 includes several openings. The openings include angular slot 112 and two holes 114 and 116. Angular slot 112 allows guiding rod 40 to slide into the bottom of the bracket and secures it there by frictional forces. These frictional forces are described in detail in the discussion of FIGS. 7A and 7B. Slot 112 prevents guiding rod 40 from sliding out of the slot during use of the apparatus. The location of holes 114 and 116 corresponds to the placement of holes in rectangular cube 130 depicted in FIG. 3D and the placement of holes in the overhead bar.

Illustrated in FIG. 3D is a side view of bracket 30 with spacer 130. The spacer is used to physically connect bottom portion 120 and overhead bar 30. The rectangular cube may be placed between flat top portion 122 and overhead bar 30 without deviating from the spirit of the invention. FIG. 3D also provides a view of the angle between two angled top portions 124 and 110.

FIG. 3E illustrates an alternative design of bracket 30. The alternative design of bracket 30 eliminates the requirement of spacer 130. The alternative design narrows the gap between the bottom portion and overhead bar 30. Holes 114, 115, 116 and 117 are provided for attachment of the spacer and bracket to the overhead bar. To accommodate attachment with two machine screws, holes 115 and 117 are generally parallel with holes 114 and 116.

Referring now to FIGS. 4A, 4B and 4C, depicted in detail are suction hose 50 and filter 70 coupled with hose 50. As shown in FIG. 4A, suction hose 50 includes capped top end 300 with circular connector 302 for connection to the pressure sprayer. FIG. 4B provides a side view of top end 300 and circular connector 302. Circular connecter 302 in the preferred embodiment is a threaded coupling. Of course, other embodiments can accommodate different connections besides threaded connections. The connector allows for the flow of fluid from the hose to the pressure sprayer. It may be made of a metallic alloy, rubber, plastic or other materials suitable for the connector. Tube 206 of the hose is typically made from a flexible material. In a preferred embodiment of the present invention, the hose is made from a flexible clear plastic material that returns to its original shape when bent.

FIG. 4C details the bottom end of hose 50. Filter 70 is provided with a hollow protruding member 208. Member 208 is sized to fit within tube 206. Clamp 202 couples protruding member 208 and filter 70 to tube 206. Welded to clamp 202 is ring 204. Typically, both clamp 202 and ring 204 are made of a rigid or metal material to securely hold protruding member 208 inside tube 206. However, the clamp and ring may be made of a study plastic or any other material capable of fastening tube 206 to filter 70.

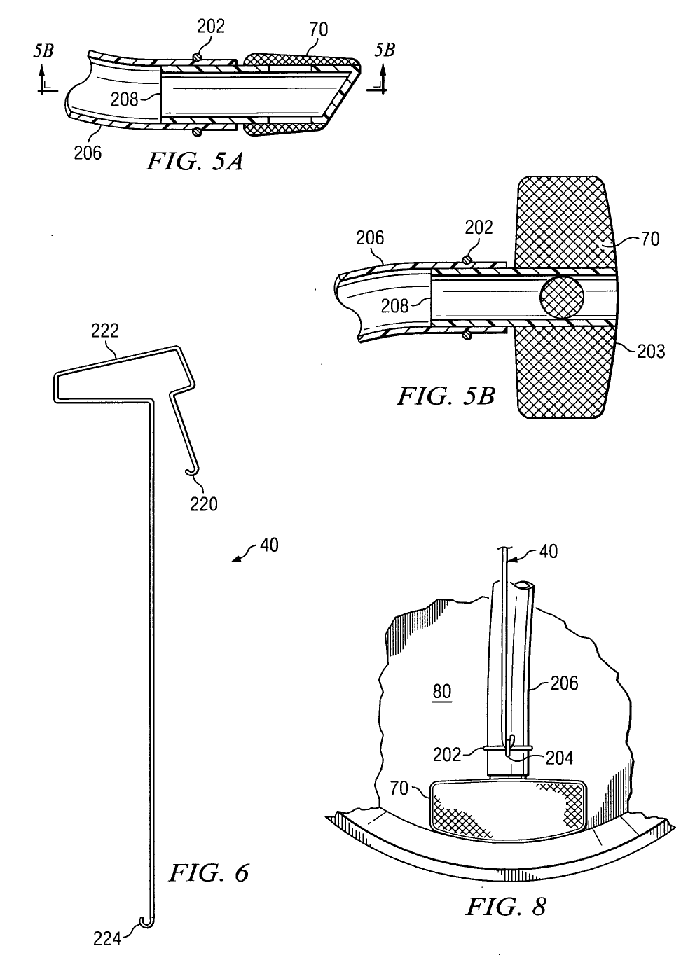

Turning to FIGS. 5A and 5B, illustrated is a cross sectional side view of filter 70 and tube 206. Hollow protruding member 208 extends from end of filter 70 to the point where the hollow protruding member is snugly secured inside tube 206 by clamp 202. In operation, the flow of fluid is directed from the end of filter 70 towards tube 206 by means of hollow protruding member 208. As shown in FIG. 5B, the opening of hollow protruding member 208 is a generally circular opening. In operation, curvature 203 in filter 70 forces hollow protruding member 208 to the lowest point in the corner of the container. Filter 70 may be constructed of plastic, rubber, or any material capable of allowing paint to pass through its surface.

Turning to FIG. 6, illustrated is an exemplary embodiment of guiding rod 40. Guiding rod 40 as depicted includes handle 222, top hook 220 and bottom hook 224. Handle 222 is used to lift guiding rod 40. Bottom hook 224 connects guiding rod 40 to ring 204. Top hook 220 secures guiding rod 40 when the device is in the “down” or “use” position by clipping to the outside surface of the bracket. Top hook 220 and bottom hook 224 are described in more detail in relation to FIGS. 7A and 7B.

Referring now to FIG. 7A, illustrated is a side view of the device in the “up” or “storage” position. In this position, hose 50 is bent upwards and is held by the friction of rod 40 against the top slot and bottom angled slot of the bracket. Hose 50 generally is straight when no force is applied, when hose 50 is bent, hose 50 exerts a force pulling away from guiding rod 40. The force pulls guiding rod 40 into angled slot 112. This force also causes guiding rod 40 to be pushed into circular groove 108. By pushing forward on the handle and moving the guiding rod out of circular groove 108, the frictional force suspending the rod in the storage position can be overcome and guiding rod 40 may be pushed down into the “use” position.

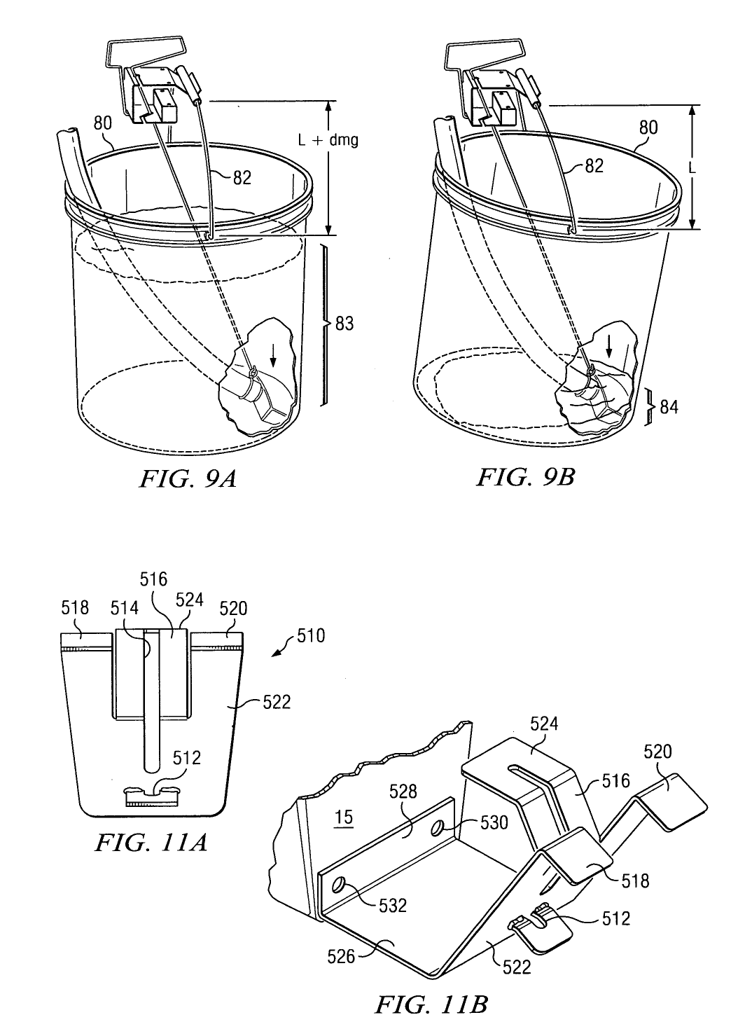

FIG. 7B shows the device is in the “down” or “use” position. In the “use” position top hook 220 attaches to the bottom corner of bracket 30 to prevent forces from pushing rod 40 and hose 50 upwards. This force is further described in reference to FIG. 9. Top hook 220 along with friction between rod 40 and the bracket locks the apparatus in the “use” position. Bottom hook 224 is also attached to ring 204 coupled with clamp 202 which is fastened around the hose to secure the filter in place in the bottom corner of the container.

Referring now to FIG. 8, a portion of the device is shown in the “use” position inside container 80. In the “use” position, filter 70 and hose 50 are positioned at the bottom corner of container 80. This positioning allows filter 70 and hose 50 to collect the fluid in container 80 even when the fluid level is very low. Ideally, almost all of the fluid in the container can be utilized by the sprayer before refilling the container or replacing it.

To better demonstrate how the filter and hose collect the last remaining fluid in the container, FIGS. 9A and 9B depict the motion of the container as fluid is used. In the illustration of FIG. 9A, depicted is container 80 with handle 82 and with a high fluid level 83. Typically, handle 82 of the container is made of a drawn steel wire or other material having a certain spring constant.

There is a length “L” measured by the distance from the top of handle 82 to the level where the handle is attached to container 80 for an empty container. When a large amount of fluid is present in the container, the weight of the fluid causes bending of handle 82 thereby increasing the distance from the top of the handle to the level where the handle is attached to the container. For example, this distance may be represented by “L+ΔL”, where “ΔL” is the change in length. Also, in FIG. 9A, the hose 50 and filter 70 combination are held on the bottom corner of container 80 by guiding rod 40.

Turning to FIG. 9B, illustrated is the same container 80, but with a lower fluid level 84. When the fluid level is lower, the distance from the top of the handle to the level where the handle is attached to the container is approximately L. The hose and filter combination is held firmly on the bottom corner of the container by guiding rod 40 and so is not allowed to move even as the fluid level becomes lower. However, because the distance from the top of the handle to the level where the handle is attached to the container is shorter due to the contraction of the handle, the hose and filter apply a force on the corner of the container. This force causes a tilting action of the container. The tilt forces fluid to collect in the corner of the container where the hose and filter are located.

Depicted in FIG. 10 is a second exemplary embodiment of the present invention. FIG. 10 shows pressure sprayer 15 mounted on movable cart 95. Affixed to pressure sprayer 15 is bracket 510 and hose 55 connected to the low pressure fluid inlet of pressure sprayer 15. Guiding rod 40 is inserted between openings in bracket 510 and attached to hose 55. Bracket 510 of FIG. 10 also provides an area for hanging container 80. Because the weight of a full container of fluid is significant, the bracket is preferably made of a sturdy material such as rigid plastic or metal. Bracket 510 of the second embodiment is not fastened to an overhead bar, but is instead fastened the bottom portion of the pressure sprayer by nuts or screws.

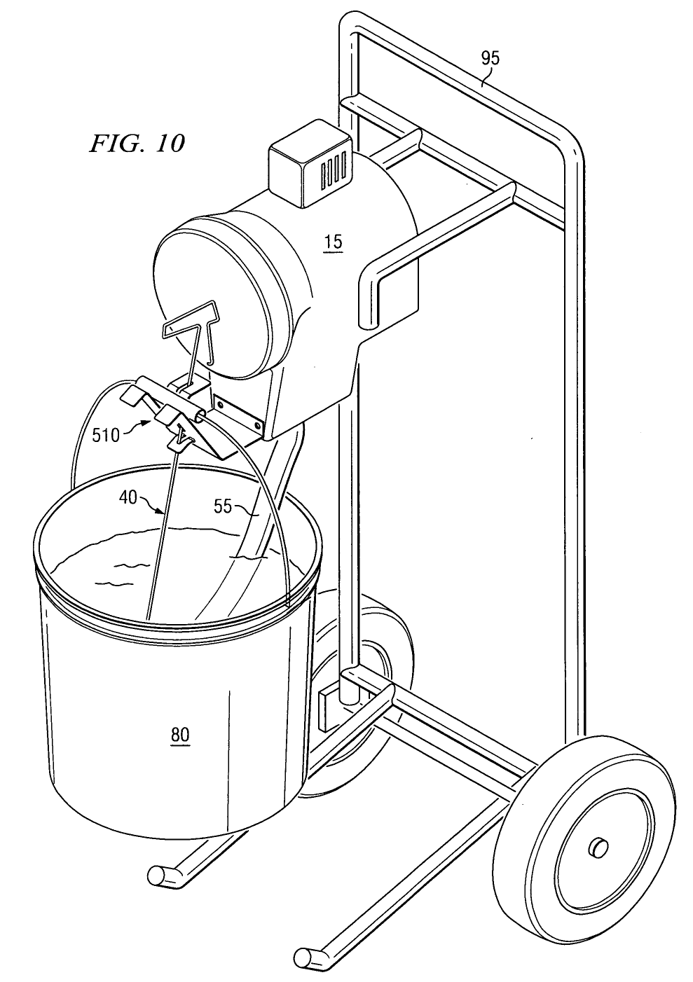

FIGS. 11A and 11B depict a front view and an isometric view of bracket 510 of the second exemplary embodiment. Bracket 510 includes two folded fingers 518 and 520, notch 512, upward angled piece 516, flat piece 524 with slot 514 extending from it to the end of upward angled piece 516. Bracket 510 may be cast or bent and cut from flat stock material.

In reference to FIG. 11B, bracket 510 also includes flat bottom piece 526 with perpendicular bend 528. The perpendicular bend has two holes 530 and 532 which correspond with holes on pressure sprayer 15 in the preferred embodiment. Two screws or bolts are used to securely fasten bracket 510 to pressure sprayer 15. Other attachment means will work as well.

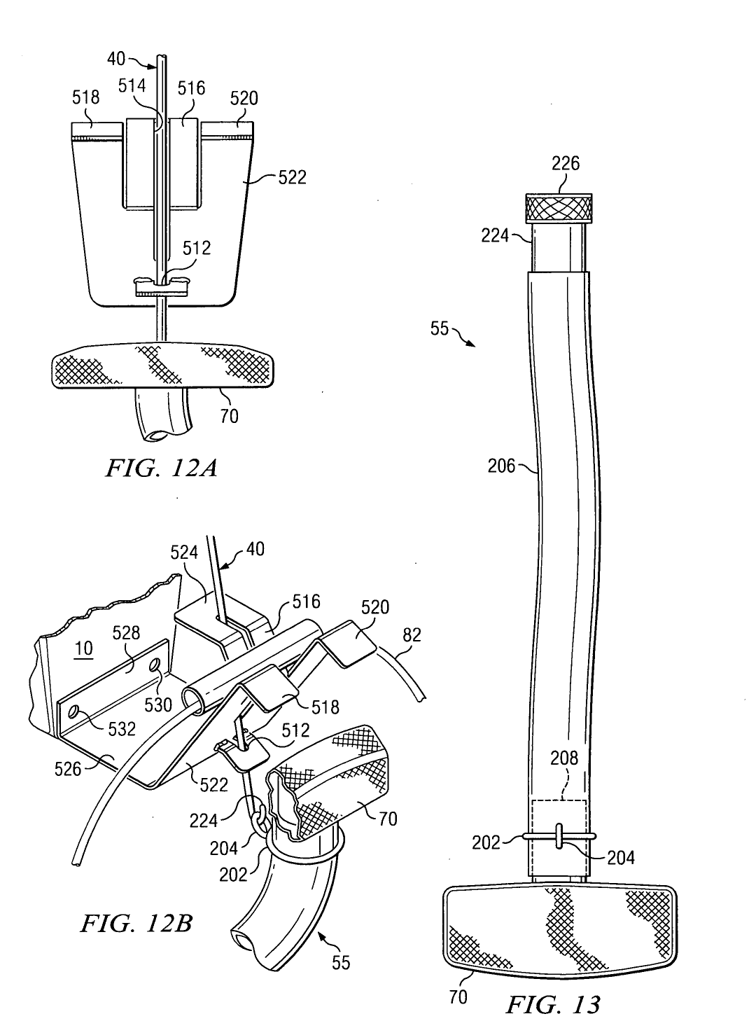

FIGS. 12A and 12B depict a front view and a side view of guiding rod 40 inserted into bracket 510. Guiding rod 40 is inserted through notch 512 and rests on the portion of slot 514 in flat piece 524. FIG. 12A also depicts filter 70 in the “up” position relative to bracket 510.

Referring now to FIG. 12B, depicted is bottom hook 228 in guiding rod 40. Bottom hook 224 latches onto circular structure 204 of clamp 202 attached to hose 55. In the “up” position, the top of filter 70 is elevated slightly above the end of notch 512. The “down” position of the second preferred embodiment is the same as that of the first preferred embodiment. In the down position filter 70 is firmly held at the bottom corner of the container by guiding rod 40.

Turning now to FIG. 13, illustrated is a second embodiment of hose 55 and filter 70. Hose 55 includes circular connector 226 at the top and metallic coupling 224 to integrate circular connector 226 with tube 206. Circular connector 226 is threaded onto a corresponding connector on the bottom of the pressure sprayer (not shown). Coupled to the bottom end of tube 206 is filter 70. Filter 70 is coupled to tube 206 by means of a hollow protruding member 208 of filter 70 which is fitted inside tube 206 and fastened by clamp 202. Circular structure 204 is formed on clamp 202. The hook on guiding rod 40 engages the circular structure and guides and supports filter 70 on the bottom cover of the container.

The second embodiment of the present invention for all purposes function in the same manner as the first described embodiment.

The present invention may be embodied in other specific forms without departing from its spirit or essential characteristics. The described embodiments are to be considered in all respects only as illustrative and in any way restrictive. The scope of the invention is, therefore, indicated by the appended claims rather than by the foregoing description. All changes which come within the meaning and range of equivalency of the claims are to be embraced within their scope.

1. An apparatus for drawing fluid from a container for a pressurized sprayer having a support member comprising:
a bracket means, attached to the support member, for holding the container;
a rod having a top end and a bottom end releasably attached to the bracket means;
a hose with first end and a second end, wherein the first end is attached to the pressurized sprayer and the second end is attached to the bottom end of the rod and;
wherein the rod applies a force to the container as fluid is drawn from the container.

2. The apparatus of claim 1 wherein the support member is a support handle.

3. The apparatus of claim 1 wherein the support member is a support plate.

4. The apparatus of claim 1 further comprising a filter coupled to the second end of the hose.

5. The apparatus of claim 4 wherein the filter has a semi-elliptical shape.

6. The apparatus of claim 1 wherein the bracket is made of a metal.

7. The apparatus of claim 1 wherein the bracket is made of a plastic.

8. The apparatus of claim 2 wherein the bracket means has a top portion with a first slot incorporating a retaining groove and a bottom portion with an angular second slot.

9. The apparatus of claim 8 wherein the rod is frictionally held in the bracket means by the retaining groove and the angular second slot.

10. The apparatus of claim 3 wherein the bracket means has an angled slot.

11. The apparatus of claim 10 wherein the rod is frictionally held in the angled slot and the opening.

12. The apparatus of claim 1 wherein the second end is linked to the bottom end by a hook on the bottom end attached to a loop connector on the second end.

13. An apparatus for drawing fluid from a pressure sprayer having a support structure comprising:
a container, supported by the support structure, tilted relative to the pressure sprayer;
a hose with a first end and a second end wherein the first end is attached to the pressure sprayer; and,
a rod linked to the second end of the hose and arranged to hold the second end of the hose at the bottom of the container and tilt the container.

14. The apparatus of claim 13 wherein the hanging structure is a support handle.

15. The apparatus of claim 13 wherein the hanging structure is a bracket.

16. The apparatus of claim 15 wherein the rod is hooked to the bracket.

17. The apparatus of claim 13 wherein the tilt of the container is less than 30 degrees.

18. A device for drawing fluid from a container having a handle comprising:
a support means for supporting the handle;
a suction means, adjacent to the bottom of the container, for drawing the fluid from the container; and
a suspension means for maintaining a corner of the container in a stationary position as fluid is drawn from the container;
whereby the container is tilted by contraction of the handle as fluid is drawn from the container.

19. The device of claim 18 wherein the suspension means includes a rod means supported by the support means and attached to the suction means whereby the rod means holds the suction means adjacent to the corner of the container.

20. The device of claim 18 wherein the handle is semiarcuate.

21. A method for drawing fluid from a hanging container comprising the steps of:
providing a fluid removal hose having an exhaust end and a suction end adjacent to the bottom corner of the container;
providing a stationary corner support member adjacent to the bottom corner of the container, and;
removing fluid from the container whereby the stationary corner support member applies a force to the bottom corner of the container.

22. The method of claim 21 wherein the hose is held adjacent to the bottom corner of the container by a rod linked to the second end.

23. The method of claim 22 further comprising the steps of:
applying a force to the bottom corner of the container as fluid is removed with the rod.

24. The method of claim 21 further comprising the step of:
continuing to remove fluid from the container as the container tilts from the applied force.
